(19) United States
(12) Patent Application Publication
(10) Pub. No.: US 2025/0007257 A1
(43) Pub. Date: Jan. 2, 2025

(54) Devices and Methods For Preparing Electrical Wiring

(71) Applicant: Klein Tools, Inc., Lincolnshire, IL (US)

(72) Inventors: Stephen Powers, Grand Prairie, TX (US); Jordan L. Fisher, Arlington, TX (US); Max Darrow, Grand Prairie, TX (US)

(73) Assignee: Klein Tools, Inc., Lincolnshire, IL (US)

(21) Appl. No.: 18/216,947

(22) Filed: Jun. 30, 2023

(51) Int. Cl. H02G 1/12

(52) U.S. Cl. CPC H02G 1/1212; H02G 1/1239

(57) ABSTRACT

A device for removing the sheathing from an electrical cable includes a body having a first end, a second end opposite the first end, a longitudinal portion therebetween, and a passage extending through the longitudinal portion from the first end to the second end. The second end defines a first terminal portion of a channel extending along at least a portion of the longitudinal portion of the body. A first cutting edge is disposed within the passage and configured to cut a sheathing of an electrical cable extending through the passage upon the device being moved in a first direction. A second cutting edge is disposed at an angle to the first cutting edge at a second terminal portion of the channel opposite the first terminal portion, and configured to cut the sheathing from the electrical cable upon the device being moved in a second direction opposite the first direction.

### BACKGROUND

Insulated electrical wires are often covered in a protective outer sheathing. The outer sheathing may protect the wires from damage, such as abrasion, cuts, or exposure to corrosive chemicals. When working on the electrical wires it may be desirable to remove part of the sheathing in order to access a portion of the insulated electrical wire.

To remove the desired part of the sheathing, a user may slit or cut lengthwise along the sheathing, using, for example, a utility knife or a cutting (e.g., ripping) tool. The user may pull the lengthwise slit portion of sheathing away from the insulated electrical wires. The user may then cut the pulled away portion of sheathing generally transverse to the slit to leave a portion of insulated electrical wire free from sheathing.

Utility knives may cut too deep, cutting past the sheathing and damaging the underlying electrical wire. Utility knives may also be difficult to handle which may pose safety risks to the user. Some cutting (e.g., ripping) tools require the user to cut the sheathing longitudinally then remove the tool, readjust grip on the sheathing to pull the sheathing away from the electrical wire, then use a separate tool, such as the utility knife, to radially cut the sheathing. This may be cumbersome for the user, often requiring the use of both hands and multiple tools to carry out. When an electrician is finishing out an electrical box, such as an outlet box, switch box, junction box, or breaker box, they will need to first remove the sheathing from a portion of a sheathed cable extending into the box, then remove insulation from portions of each of the insulated electrical wires exposed after the sheathing is removed, and then prep the exposed portions of the electrical wires for connection to a conductor, such a conductor terminal on an electrical outlet, which will often require that one or more of the exposed portions of the electric wires be formed into a loop. Conventionally, an electrician is required to utilize multiple different hand tools to perform these operations.

### SUMMARY

The following are example embodiments of methods and devices that could be claimed in this disclosure.

In a first example embodiment, a device for removing the sheathing from an electrical cable is disclosed. The device includes a body having a first end, a second end opposite the first end, a longitudinal portion therebetween, and a passage extending through the longitudinal portion from the first end to the second end. The second end defines a first terminal portion of a channel extending along at least a portion of the longitudinal portion of the body. The device also includes a first cutting edge disposed within the passage. The first cutting edge is configured to cut a sheathing of an electrical cable extending through the passage upon the device being moved in a first direction relative to the electrical cable. The device further includes a second cutting edge disposed at an angle to the first cutting edge at a second terminal portion of the channel opposite the first terminal portion. The second cutting edge is configured to cut a sheathing from an electrical cable upon the device being moved in a second direction opposite the first direction with the sheathing extending into the channel.

In an embodiment, the first cutting edge has an arcuate profile.

In an embodiment, the second cutting edge is linear.

In an embodiment, the angle is orthogonal.

In an embodiment, the device further includes an impingement disposed in the channel proximate to the second cutting edge.

In such an embodiment, the impingement is radially offset from the second cutting edge.

In such an embodiment, the impingement is configured to restrain a material for cutting by the second cutting edge.

In an embodiment, the first terminal portion of the channel and the second terminal portion of the channel have a same centerline.

In an embodiment, the channel bends at an angle such that the first terminal portion of the channel is angularly offset from the second terminal portion of the channel.

In an embodiment, the body further includes a magnet.

In an embodiment, the device further includes a wire stripping assembly disposed at the second end of the body. The wire stripping assembly includes a first set of parallel facing cutting edges. The wire stripping assembly also includes a second set of parallel facing cutting edges offset from the first set. The second set of parallel facing cutting edges is parallel to the first set.

In an embodiment, the longitudinal portion defines a longitudinal axis and the first and second directions are parallel to the longitudinal axis.

In another example embodiment, a method for removing a sheath from a sheathed wire cable is disclosed. The method includes inserting the sheathed wire cable through an aperture of a device. The device also includes moving the device in a first direction, where a first cutting edge slits the sheath along a longitudinal length of the sheath as the device is moved in the first direction. The method further includes moving the device in a second direction opposite the first direction, where a second cutting edge of the device cuts the sheath so as to detach a portion of the sheath from the wire.

In an embodiment, prior to moving the device in the second direction the method further includes engaging the portion with an impingement.

In an embodiment, prior to moving the device in the second direction the method further includes rotating the device 90 degrees in a radial direction.

In still another example embodiment, a device is disclosed. The device includes a body having a first end, a second end opposite the first end, and a passage extending through a longitudinal portion from the first end to the second end. The second end defining a first terminal portion of a channel extending along at least a longitudinal portion of the body. The device also includes a first cutting edge disposed within the passage. The first cutting edge is configured to cut a sheathing from an electrical cable extending through the passage when the device is moved in a first direction relative to the electrical cable. The device further includes a second cutting edge disposed at an angle to the first cutting edge at a second terminal portion of the channel opposite the first terminal portion. The second cutting edge is configured to cut a sheathing from an electrical cable when the device is moved in a second direction opposite the first direction with the sheathing extending into the channel. The device additionally includes a wire stripping assembly at the second end of the body. The wire stripping assembly includes a first set of parallel facing cutting edges. The wire stripping assembly also includes a second set of parallel facing cutting edges offset from the first set of parallel facing cutting edges. The first and second sets of parallel facing cutting edges being parallel to one another.

In an embodiment, the first set and second set of parallel facing cutting edges share a centerline.

In an embodiment, the first set of parallel facing cutting edges is spaced by a first distance and the second set of parallel facing cutting edges is spaced by a second distance less than the first distance.

In an embodiment, the wire stripping assembly further comprises an opening adjacent to a first end of the first set to allow insertion of an insulated wire therebetween.

In an embodiment, a first cutting edge from the first set of parallel facing cutting edges and a first cutting edge from the second set of parallel facing cutting edges are defined by a first component. A second cutting edge from the first set and a second cutting piece from the second set are defined by a second component fixed relative to the first component

In yet another example embodiment, a wire stripping device is provided. The wire stripping device includes a body defining an opening. The wire stripping device also includes a blade assembly. The blade assembly includes a first set of parallel facing cutting edges disposed on either side of the opening at a first distance. The blade assembly also includes a second set of parallel facing cutting edges adjacent to the first set and disposed on either side of the opening at a second distance different than the first distance. The second set of parallel facing cutting edges is parallel to the first set.

In an embodiment, the blade assembly is a single piece construction.

In an embodiment, the blade assembly includes a first piece. The first piece includes a first cutting edge from the first set and a first cutting edge from the second set. The blade assembly also includes a second piece facing the first piece. The second piece comprises a second cutting edge from the first set and a second cutting edge from the second set.

In an embodiment, the first set of parallel facing cutting edges are configured to strip a first gauge size, and the second set of parallel facing cutting edges are configured to strip a second gauge size different than the first gauge size.

In a further example embodiment, a method for removing insulating material from a wire is provided. The method includes inserting the wire perpendicularly into an opening of a device comprising parallel facing cutting edges disposed on either side of the opening. The method also includes engaging, simultaneously, the insulating material with both of the parallel facing cutting edges such that a portion of the insulating material on radially opposite sides of the wire is cut. The method further includes rotating the device 90 degrees to form a cut portion of insulating material. The method additionally includes removing the cut portion of insulating material from the wire.

It should be understood that the inventive concepts disclosed herein do not require each of the features discussed above, may include any combination of the features discussed, and may include features not specifically discussed above.

### BRIEF DESCRIPTION OF THE DRAWINGS

FIG. 1A is a top view of a handheld tool, according to example embodiments.

FIG. 1B is a front view of the handheld tool shown in FIG. 1A.

FIG. 1C is a rear view of the handheld tool shown in FIG. 1A.

FIG. 2 is a cutaway view of the handheld tool 100 removing a sheathing from a wire cable, according to example embodiments.

FIG. 3 is a bottom view of the handheld tool shown in FIG. 1A.

FIG. 4 is an exploded perspective view of the handheld tool shown in FIG. 1A.

FIG. 5 is a perspective view of another handheld tool, according to example embodiments.

FIG. 6A is a side view of a cutting blade utilized on a handheld tool, according to example embodiments.

FIG. 6B is a perspective view of another cutting blade, according to example embodiments.

FIG. 7A is a cutaway view of a portion of a handheld tool, according to example embodiments.

FIG. 7B is a cutaway view of a portion of the handheld tool of FIG. 1A, according to example embodiments.

FIG. 8A is a bottom view of a wire stripping assembly, according to example embodiments.

FIG. 8B is a bottom view of another wire stripping assembly, according to example embodiments.

FIG. 9 is a flow chart of a method for removing a sheath from a sheathed wire cable, according to example embodiments.

FIG. 10 is a flow chart of method for removing insulating material from a wire, according to example embodiments.

### DETAILED DESCRIPTION

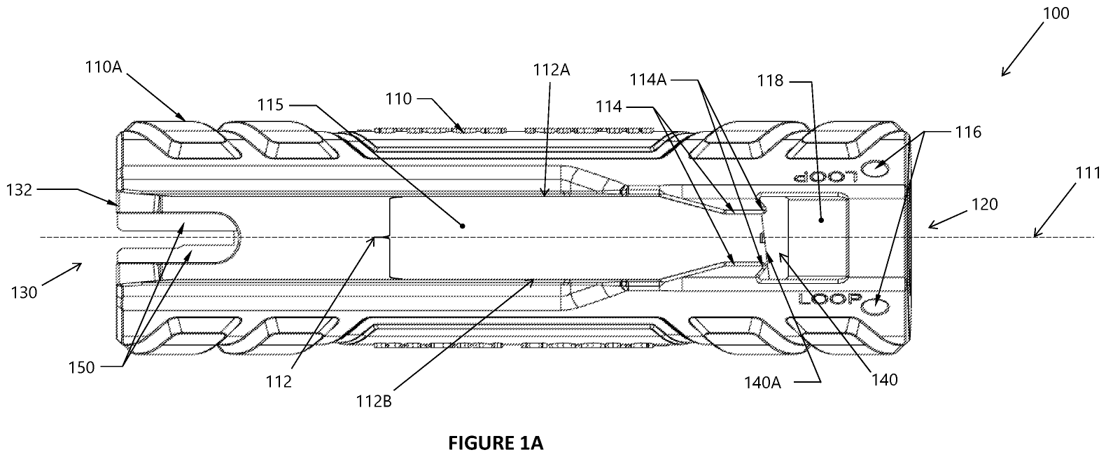

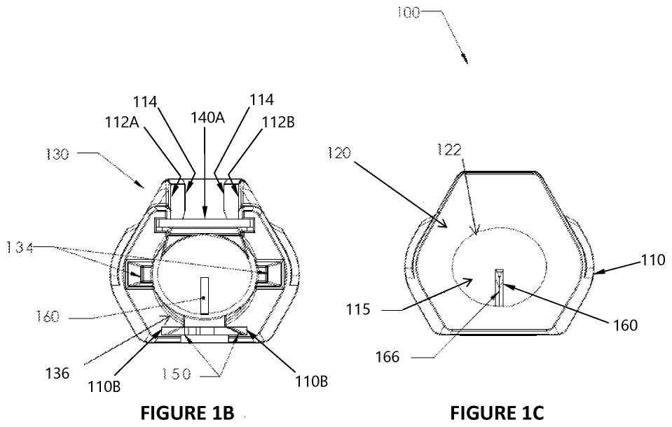

FIG. 1A is a top view of a handheld tool 100, according to example embodiments. As shown, the handheld tool 100 includes a body 110 having a first end 120, a second end 130, a through passage 115 extending from the first end 120 to the second end 130, and a channel 112 disposed on a side of the through passage 115. The second end 130 is located opposite the first end 120 and defines an aperture 136 that defines a first terminal portion 132 of the channel 112. The channel 112 extends along a length of the body 110, such as along a longitudinal axis 111, to a second terminal portion 118 of the channel 112. The through passage 115 is defined at the first end 120 by an aperture 122 and at the second end 130 by the aperture 136. Thus, the through passage 115 may extend along the entire length of the body 110 along the longitudinal axis 111.

A cutting blade 160, shown and described with respect to FIG. 1C, is disposed within the through passage 115 proximate to the first end 120 (e.g., disposed within the through passage between 0 and 0.25 inches from the first end or between 0.25 inches and 0.50 inches from the first end). The cutting blade 160 is oriented with a cutting edge 166 that faces toward the first end 120. In some examples, the cutting blade 160 oriented towards the first end 120, may be a first direction. As shown with respect to FIG. 1C, the cutting blade 160 is parallel with the longitudinal axis 111 of the body 110, such that the cutting blade 160 may be in-line with the through passage 115 and facing (e.g., oriented towards) the first end 120. For example, the cutting blade 160 may be parallel with a longitudinal cross-section of the handheld tool 100.

However, in other examples the cutting blade 160 may be non-parallel with the longitudinal axis of the body. For example, the cutting blade 160 may form an angle with the longitudinal axis (a) between a 0 and 10 degree angle, (b) between a 10 and 20 degree angle, (c) between a 20 and 30 degree angle, (d) between a 30 and 40 degree angle, (e) between a 40 and 50 degree angle, or (f) between a 50 and 60 degree angle. An embodiment using smallest angle range (a) allows for a more gradual slice of sheathing and requires less force to operate the handheld tool 100. The intermediate ranges (b)-(e) make a more abrupt slices and require more force, while the largest range (f) makes the most abrupt slice and requires most force.

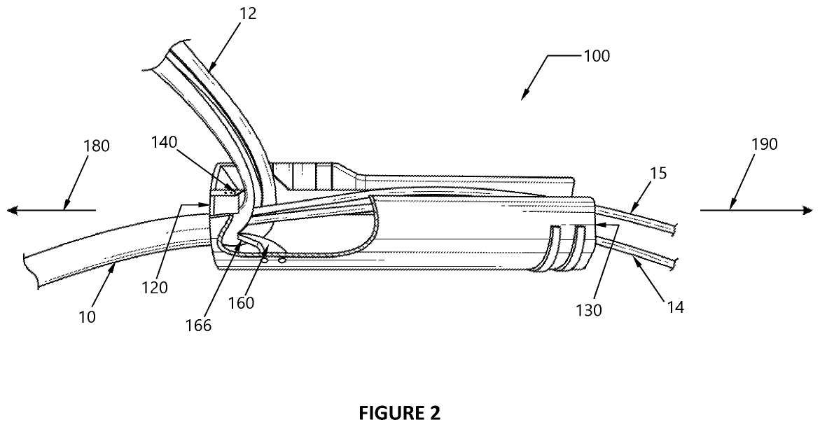

In some examples, the handheld tool 100 may include a first cutting blade and a second cutting blade. The cutting blade 160 may be the first cutting blade and the cutting blade 140 may be the second cutting blade. The cutting blade 160 may function to cut along a longitudinal length of a material inserted into the aperture 122. For example, the sheathed wire cable may be inserted into the aperture 122 and placed in contact with the cutting blade 160. Within examples, the handheld tool 100 may be moved along a length of wire cable, such as in the direction indicated by arrow 180 in FIG. 2. As the handheld tool 100 is moved along the length of the wire cable, the cutting blade 160 will cut (e.g. slit) the sheathing along the longitudinal length. In some examples, cutting the sheathing along the longitudinal length will allow the slit (e.g. cut) portion of sheathing to be pulled away from the insulated wires previously encapsulated by the sheathing. Within examples, the pulled away portion of the sheathing may then be severed by the second cutting blade, such as the cutting blade 140, when the tool 100 is moved relative to the pulled away portion of the sheathing in the direction indicated by arrow 190 in FIG. 2.

In some examples, a first portion of the cutting blade 160 may be recessed within the body 110, and a second portion of the cutting blade 160 having the cutting edge 166 formed thereon may extend radially inward from the through passage 115. The second portion of the cutting blade 160 may have a length sufficient for cutting (e.g., slitting) an encasing material, such as the sheathing, without cutting an encased material, such as the insulated wire(s). By only cutting the sheathing material, the cutting blade 160 may reduce damage that may otherwise occur when longitudinally cutting the wire cable. Thus, the cutting blade 160 may reduce undesired and/or unintentional cutting of encased material while effectively and efficiently cutting the encasing material.

As shown in FIG. 1A, the handheld tool 100 includes the cutting blade 140 located at the second terminal portion 118 of the channel 112. The second terminal portion 118 of the channel 112 is be located opposite the first terminal portion 132. In some examples, the cutting blade 140 may span a width of the channel 112, such as from a first side 112A to a second side 112B as shown in FIG. 1A. Thus, the cutting blade 140 may have a cutting edge 140A that is disposed substantially perpendicular to the longitudinal axis 111 of the body 110. In some examples, the cutting blade 140 and/or cutting edge 140A may be oriented at an angle substantially towards the first terminal portion 132 of the channel 112. For example, the cutting blade edge 140A may be parallel to the first terminal portion 132 of the channel 112 (e.g., perpendicular to the longitudinal axis 111). However, in other examples, including the example shown in FIG. 1A, the cutting edge 140A may form an angle with the longitudinal axis 111 (e.g., between a 0 and 10 degree angle, between a 10 and 20 degree angle, between a 20 and 30 degree angle, between a 30 and 40 degree angle, between a 40 and 50 degree angle, between a 50 and 60 degree angle, between a 60 and 70 degree angle, between a 70 and 80 degree angle, or between a 80 and 90 degree).

The cutting blade 140 may function to detachably cut a sheathing from a sheathed wire cable. For example, it may be desirable to remove sheathing, such as a protective sheathing, from the wire cable that has been cut along a longitudinal length, such as previously described by the blade 160. The longitudinally cut sheathing (e.g., the sheathing slit by the cutting blade 160) may be placed in contact with the cutting blade 140 which may cut the sheathing generally transverse to the slit produced by the blade 160, detaching the sheathing from the wire cable.

As shown in FIG. 1A, the first side 112A and the second side 112B of the channel 112 are defined by the body 110 along the longitudinal axis 111. In some examples, the channel 112 may be configured to receive a slit portion of sheathing that has been pulled away from a portion of a sheathed wire cable. The channel 112 may guide the slit portion of sheathing toward the cutting blade 140.

In some examples, one or more impingements 114 may be located proximate to the second terminal portion 118 of the channel 112. Within examples, the impingements 114 may be disposed on a radial periphery of the channel 112. For example, the impingement may be radially offset (e.g., radially outward) from the cutting blade 140. The impingements 114 may be located on the first side 112A and/or the second side 112B of the channel 112 and extend toward the respective opposite side of the channel 112. In some examples, the impingements 114 may serve to restrain movement of the slit sheathing during cutting by the cutting blade 140. For instance, the slit sheathing may be pulled through an opening defined by the first and second sides 112A and 112B of the channel 112 and placed in contact with a portion of the impingements 114, such as a hook-shaped portion 114A of the impingements 114 oriented towards the second terminal portion 118. The impingements 114 may resist movement of the sheathing to allow the cutting blade 140 to cut the sheathing from the wire cable as a user translates the tool 100 relative to the wire cable and sheathing, such as for example in the direction indicated by arrow 190 in FIG. 2.

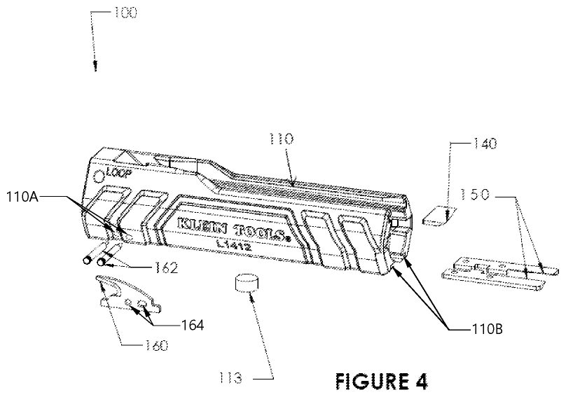

In some examples, the handheld tool 100 may include a wire stripping assembly 150. Within examples, the wire stripping assembly 150 may be disposed on an outer surface 110A of the body 110 at the second end 130 or on inner surface of the body 110 that defines a the through passage 115. As shown in FIGS. 1B and 4, the wire stripping assembly 150 may be located in a slot 110B or slots 110B formed in the body 110 opposite the channel 112, such as opposite the first and second sides 112A and 112B. However, other locations are possible.

In some examples, the wire stripping assembly 150 may serve to cut and remove material from around a wire, such as an insulating material from around an electrical wire. For example, in operation the user may first detachably remove the sheathing from the wire cable using the cutting blade 140 to expose the insulated electrical wires and then use the wire stripping assembly 150 to remove insulation from the exposed insulated electric wires. That is, the handheld tool 100 can longitudinally and transversely cut the sheathing without the need to remove the tool from the sheathed wire cable between each of the cuts. The wire stripping assembly 150 may then be used to cut and remove (e.g., strip) a portion of insulation from the insulated electrical wires to allow the user to access an exposed portion of the electrical wire.

Thus, by including the wire stripping assembly 150 on the handheld tool 100, the user may remove sheathing and strip insulation with a single tool. Performing both functions using the handheld tool 100 may increase efficiency by reducing the number of tools needed on a job site.

Within examples, the handheld tool 100 may include one or more looping tools 116. In some examples the looping tool 116 may be an aperture, such as a cylindrical bore, defined by the body 110. The looping tool 116 may be oriented at an angle, such as a parallel angle (e.g., zero degrees), to the first and/or second ends 120 and/or 130 of the handheld tool 100. The looping tool 116 may allow insertion of material, such as the end of an electric wire, for forming a loop. For example, the end of the electric wire may be inserted through into the looping tool 116 and the handheld tool 100 may be radially rotated (e.g., clockwise or counterclockwise) to form a loop in the exited electric wire, which may allow the exited electric wire to be coupled with a fastening device (e.g., a threaded fastener for a terminal on an outlet). For example, the looped electric wire may be coupled around a shank portion of the threaded fastener.

FIG. 1B is a front view of the handheld tool 100, according to example embodiments. The front view of the handheld tool 100 illustrates the second end 130 of the through passage 115, the wire stripping assembly 150 located at the second end 130, and the cutting blade 160 disposed within the through passage 115. In some examples, the second end 130 may include a torquing unit 134. The torquing unit 134 may be defined by a recessed portion of a surface of the second end 130, so as to be planar with the second end 130.

Within examples, the torquing unit 134 may be configured to receive a fastening device, such as a winged twist-on wire connector or nut. In some examples, the torquing unit 134 may comprise the recessed portion of the surface of the second end 130 on opposite sides of the through passage 115. Disposing the recessed portion on opposite sides of the through passage 115 may allow for the torquing unit 134 to receive dimensionally varied fastening devices. For example, the wing nut may include a cap (e.g., a capped wing nut). A capped portion of the capped wing nut may be disposed within the through passage 115 to allow the torquing unit 134 to engage a winged portion of the capped wing nut. When the winged portion of the wing nut is disposed within the torquing unit 134, the handheld tool 100 may be radially rotated (e.g., clockwise or counterclockwise) to engage the torquing unit 134 with the wing portion and produce torque (e.g., tightening and/or loosening) on the wing nut. Thus, the handheld tool 100 may reduce the amount of tools the user may need when performing work on the cable by allowing the user to attach and/or loosen the fastening device with the torquing unit 134. This may increase efficiency and decrease time associated with performing work on the wire cable.

FIG. 1C is a rear view of the handheld tool 100, according to example embodiments. As illustrated, the handheld tool 100 includes an aperture 122 defined by the first end 120. As shown, the aperture 122 has an ovular perimeter centered on the axis 111; however, in other examples the aperture 122 may have another geometry.

As shown in FIGS. 1B and 1C, the through passage 115 is a through hole, extending from the aperture 122 of the first end 120 to the aperture 136 of the second end 130 of the body 110. The aperture 122 may allow for material, such as the sheathed wire cable to be inserted at the first end 120 and pulled through the through passage 115 to the second end 130. As shown, the aperture 122 has a closed perimeter, having material of the body 110 disposed on all sides. However, in other examples the aperture 122 may have an open perimeter (e.g., material may not be present on some portions of the perimeter). Thus, in some examples, the through passage 115 is defined by at the first end 120 by the aperture 122 having a closed perimeter and defined at the second end 130 by the aperture 136 having an open perimeter.

While an embodiment is shown in FIGS. 1B and 1C, in other examples the cutting blade 160 may be a moldable integral component on the handheld tool 100. Integrally forming the cutting blade 160 into the handheld tool 100 may reduce manufacturing time and/or part count which may provide for a more efficient manufacturing process.

FIG. 2 is a cutaway view of the handheld tool 100 removing a sheathing 12 from a sheathed wire cable 10, according to example embodiments. To remove the sheathing 12 from the wire cable 10, the wire cable 10 is inserted through the first end 120 and into the through passage 115, such that the sheathing 12 is placed in contact with the cutting blade 160. The handheld tool 100 is then moved in a first direction 180, such as along a length of the wire cable 10. As the handheld tool 100 is moved in the first direction 180, the cutting edge 166 of the cutting blade 160 slits (e.g., cuts) along a length of the sheathing 12, exposing insulated wires 14 and a bare wire 15. The cut length of sheathing 12 and insulated wires 14 exit the handheld tool 100 at the second end 130. The cut length of sheathing 12 is then pulled away from the insulated wires 14 through the channel 112 and placed in contact with the cutting blade 140. The handheld tool 100 is then moved in a second direction 190, such that the cutting edge 140A of the cutting blade 140 severs the cut length of sheathing 12 from the wire cable 10 leaving the exposed insulated wires 14. In some examples, the second direction 190 may be opposite the first direction 180.

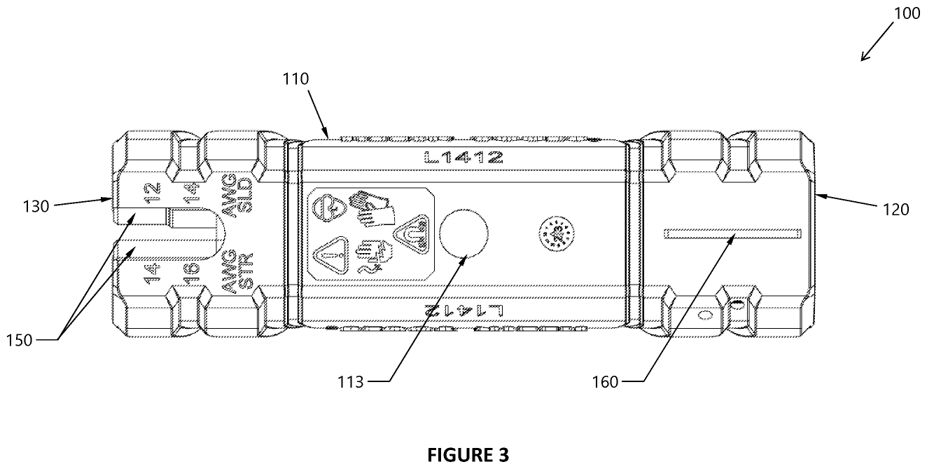

FIG. 3 is a bottom view of the handheld tool 100, according to example embodiments. As shown, a magnet 113 may be disposed within the body 110 of the handheld tool 100. In some examples, the magnet 113 may be partially recessed and/or completely recessed within the body 110 such that a surface of the magnet 113 is flush with a surface of the body 110. In some examples, the magnet 113 may be located at a midpoint along the body 110. However, in other examples, the magnet 113 may be located anywhere on the body 110. The magnet may allow the handheld tool 100 to be detachably affixed to a magnetic surface. For example, via the magnet 113, the user may secure the handheld tool 100 against a vertical wall of a metallic electrical box (e.g., a steel electrical box). The magnet 113 may provide sufficient magnetic forces to restrain movement of the handheld tool 100 to allow for placement on the vertical wall of the metallic electrical box.

FIG. 4 is an exploded perspective view of the handheld tool 100, according to example embodiments. The exploded perspective view includes the body 110, the cutting blade 140, the wire stripping assembly 150, the cutting blade 160, the magnet 113, and one or more securing rods 162.

As shown in FIG. 4, the cutting blade 160 is secured by the one or more securing rods 162. The first portion of the cutting blade 160 disposed within the body 110 is secured by the one or more securing rods 162. Cutting blade 160 may be configured, such as by defining apertures 164, to receive the one or more securing rods 162. The body 110 includes one or more apertures 110A that align with the one or more apertures 164 on the cutting blade 160. The one or more securing rods 162 are inserted into the one or more apertures 110A on the body 110 and inserted through the one or more apertures 164 on the cutting blade 160. In the example shown, the one or more securing rods 162 serve to fixedly couple the cutting blade 160 to the body 110, thus mitigating translation of the cutting blade 160 during use of the handheld tool 100. However, in other examples the cutting blade 160 may be coupled to the body 110 using another method. For example, the cutting blade 160 may be integrally formed in the body 110.

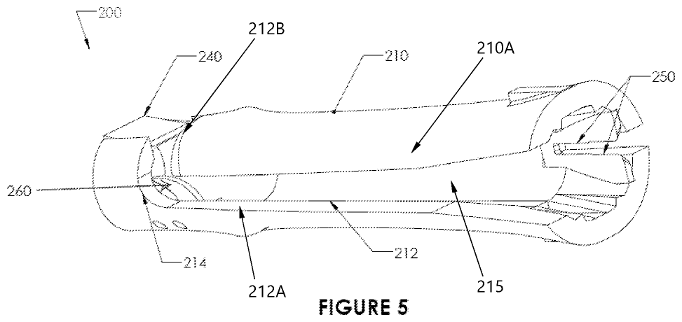

FIG. 5 is a perspective view of another handheld tool 200, according to example embodiments. The handheld tool 200 includes a body 210 defining a through passage 215 and a channel 212, a cutting blade 240, a cutting blade 260, and a wire stripping assembly 250. In some examples, the handheld tool 200 may include some or all of the functions and capabilities described with respect to the handheld tool 100. As shown, the channel 212 of the handheld tool 200 includes a channel bend 214. In some examples, the channel bend 214 may bend at an angle such that the first terminal portion of the channel 212 may be angularly offset from the second terminal portion of the channel 212.

As illustrated, an outer surface 210A of the body 210 defines the channel 212 and/or the channel bend 214. The channel 212 is partially offset from the cutting blade 240 along the longitudinal length of the body 210. In the example shown, the channel bend 214 is located proximate to the cutting blade 240, such that a first portion 212A of the channel 212 may be offset from the cutting blade 240 and the channel bend 214 may allow a second portion 212B of the channel 212 to terminate in-line with (e.g., in front of) the cutting blade 240. In examples where the channel 212 terminates in-line with the cutting blade 240, the channel 212 is defined by the cutting blade 240 and the second portion 212B of the channel 212. The second portion 212B of the channel 212 disposed opposite the cutting blade 240 may function to resist movement of a material desired to be cut by the cutting blade 240.

For example, sheathing that has been longitudinally cut by the cutting blade 260 may be pulled away from the insulated wire(s) via the channel 212 and moved through the channel bend 214 to be placed in contact with the cutting blade 240. The second portion 212B opposite the cutting blade 240 may resist movement of the pulled away portion of the sheathing so that as the handheld tool 200 is moved the cutting blade 240 may cut a radial portion of the sheathing to detach the sheathing from the insulated wire(s).

However, in other examples, the sheathing may be pulled away from the insulated wire(s) until the channel bend 214 and the handheld tool 200 may be radially rotated (e.g., clockwise or counterclockwise) to engage the pulled away sheathing with the cutting blade 240 and/or the second portion 212B opposite the cutting blade 240. Thus, in some examples, the channel bend 214 may allow for the second portion 212B opposite the cutting blade 240 to serve as an impingement surface.

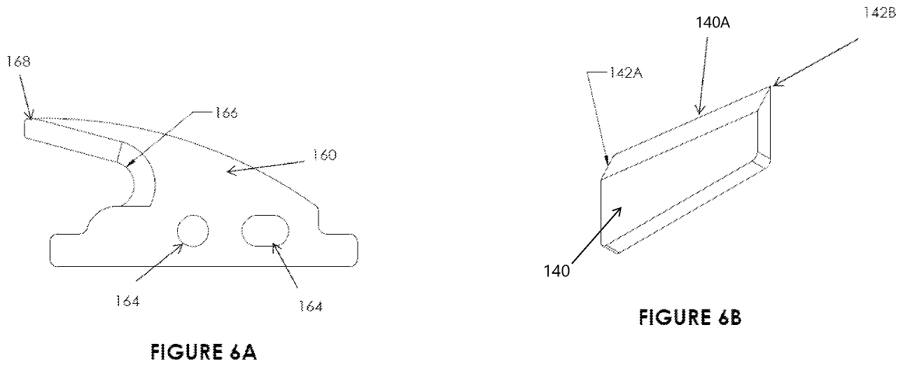

FIG. 6A is a side view of the cutting blade 160, according to example embodiments. The cutting blade 160 includes one or more apertures 164 that may be configured to receive the one or more securing rods 162. The one or more apertures 164 may be disposed within the body of a handheld tool, such as within the body 110 of the handheld tool 100. As shown, the cutting blade 160 includes a tip 168 and a cutting edge 166 having an arcuate, hook-shaped profile. However, in other examples, the cutting blade 160 may include another profile, such as a straight profile or an angle profile.

Within examples, the tip 168 may be rounded or pointed, however other profiles are contemplated. The tip 168 may engage an internal surface of an encasing material and guide the encasing material toward the cutting edge 166 of the cutting blade 160 for cutting. In some examples, the tip 168 may serve to separate the encasing material to be cut from encased material that might not be cut. For example, the tip 168 may contact an inner surface of the sheathing to guide the sheathing toward the cutting edge 166 while not engaging the insulated wire(s) encased by the sheathing. Within examples, the cutting blade 160 may be used to longitudinally cut a length of sheathing.

FIG. 6B is a perspective view of the cutting blade 140, according to example embodiments. The cutting blade 140 includes a cutting edge 140A, a first end 142A, and a second end 142B. While the cutting edge 140A shown has a zero degree angle (e.g., flat) from a first end 142A to a second end 142B, in other examples the cutting edge 140A may be angled. For example, the cutting edge 140A may have an angle between 0 and 10 degrees, and angle between 10 and 20 degrees, an angle between 20 and 30 degrees, an angle between 30 and 40 degrees, an angle between 40 and 50 degrees, an angle between 50 and 60 degrees, an angle between 60 and 70 degrees, an angle between 70 and 80 degrees, or an angle between 80 and 90 degrees from the first end 142A to the second end 142B. In some examples, the cutting edge 140A may be the second cutting edge.

When implemented on the handheld tool 100, the cutting edge 140A is preferably oriented in a different direction than the cutting edge 166. For example, the cutting edge 140A is preferably oriented towards (e.g., facing) the second end 130 while the cutting edge 166 may be oriented towards (e.g., facing) the first end 120.

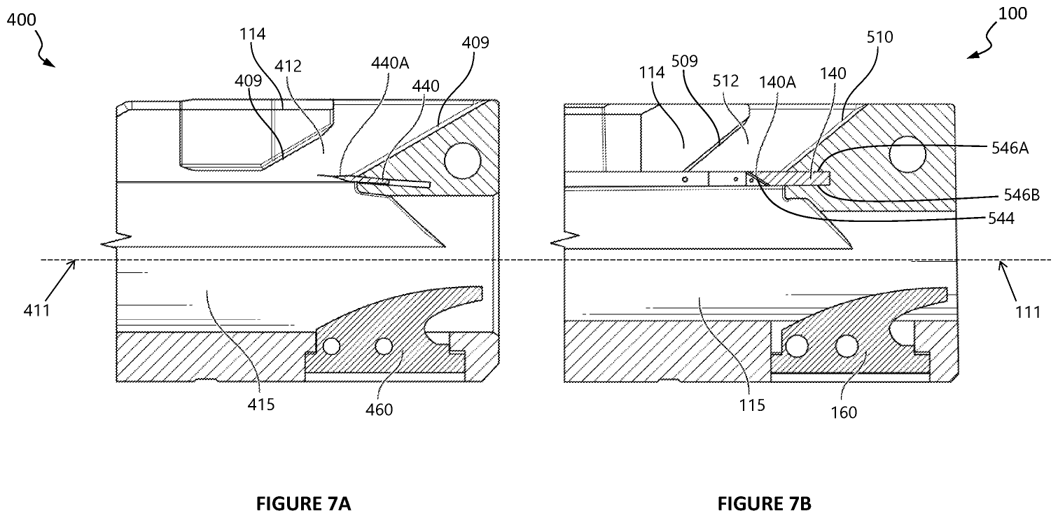

FIG. 7A is a cutaway view of a portion of a handheld tool 400, according to an alternate embodiment. The handheld tool 400 includes a cutting blade 460 disposed within a through passage 415, a pair of ramp surfaces 409, and a cutting blade 440 with cutting edge 440A disposed proximate to a channel 412. As shown, the cutting blade 440 forms an angle (e.g., not parallel) with a longitudinal axis 411 of the handheld tool 400 such that the cutting blade 440 is angled within the channel 412. Angling the cutting blade 440 within the channel 412 may allow sheathing from a wire cable to more easily engage with the cutting edge 440A during cutting. The cutting edge 440A may be a double bevel configuration, having a bevel and/or taper on either side of the cutting edge 440A. The ramp surfaces 409 may allow material, such as sheathing, to be pulled through the channel 412 and placed in contact with the cutting edge 440A. This may aid in restraining movement of the sheathing during cutting to allow the cutting edge 440A to more effective cut the sheathing.

FIG. 7B is a cutaway view of a portion of the handheld tool 100 shown in FIGS. 1A-4. The handheld tool 100 includes a planar ramp surface 509 on each of the impingements 114 and a planar ramp surface 510 at the terminal end 118 of the channel 112. In the illustrated embodiment the ramp surfaces 509 face the ramp surface 510 and are parallel to the ramp surface 510, which extends at an angle in the range of 30 to 60 degrees relative to the longitudinal axis 111. The ramp surfaces aid in properly locating the slit sheathing relative to the cutting blade 140 after the slit sheathing has been pulled away from the rest of the wire cable and before the slit sheathing is removed via cutting with the blade 140 As shown, the cutting blade 140 is disposed proximate to the channel 112 and oriented parallel (e.g., at a zero degree angle) to the longitudinal axis 111 of the handheld tool 100. The cutting edge 140A includes a bevel 544 on one side to form a single bevel configuration. The bevel 544 may be on a side oriented towards the through passage 115, such as side 546B. Including the bevel 544 on the side 546B may provide for effective cutting of material, such as sheathing, by encouraging contact of the sheathing with the cutting edge 140A.

While an embodiment is shown in FIG. 7B, in other examples the bevel 544 may be on another side, such as side 546A, disposed opposite of the side 546B. In some examples, the cutting blade 140 and/or the cutting blade 440 may be a moldable integral component on the handheld tool 500 and/or 400, respectively. Integrally forming the cutting blade 140 and/or 440 into the handheld tool 500 and/or 400, respectively, may reduce manufacturing time and/or part count which may provide for a more efficient manufacturing process.

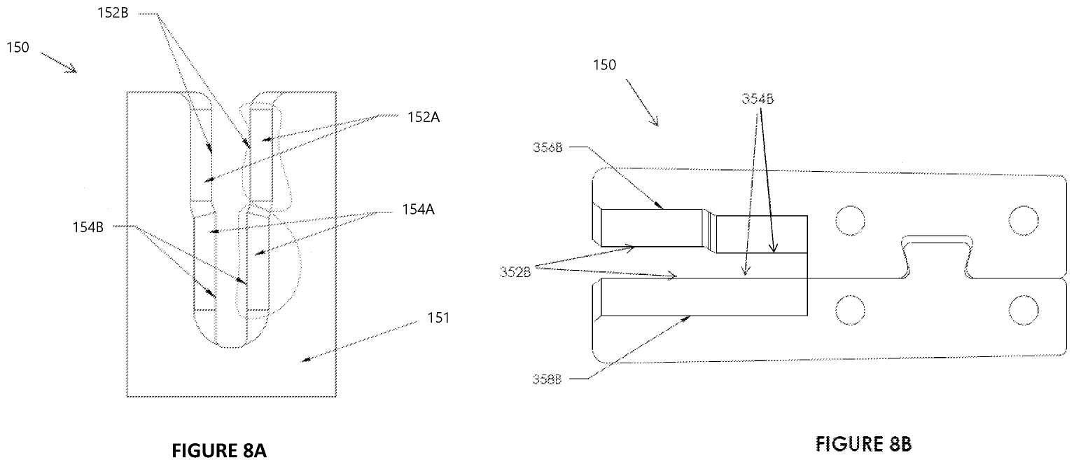

FIG. 8A is a bottom view of a wire stripping assembly 150, according to example embodiments. The wire stripping assembly 150 includes a single body 151 having a first set of parallel facing cutting blades 152A and a second set of parallel facing cutting blades 154A. The first set of parallel facing cutting blades 152A include a first set of parallel facing cutting edges 152B, and the second set of parallel facing cutting blades 154A include a second set of parallel facing cutting edges 154B. As shown, the first set of parallel facing cutting blades 152A are disposed on either side of an opening at a distance from one another. Similarly, the second set of parallel facing cutting blades 154A are on either side of the opening at a distance from one another.

In some examples, the second set of parallel facing cutting blades 154A may be adjacent to the first set of parallel facing cutting blades 152A. In some examples, the distance between the second set of parallel facing cutting edges 154B on either side of the opening may be different than the distance between the first set of parallel facing cutting edges 152B. For example, the first set of parallel facing cutting edges 152B may be on either side of the opening at a first distance, and the second set of parallel facing cutting edges 154B may be on either side of the opening at a second distance different than the first distance. In some examples, the first distance may be greater than the second distance. Having the first distance greater than the second distance may mitigate the risk of a thicker wire being cut beyond the insulation layer and damaging the electrical wire portion.

In some examples, a first cutting edge from the first set of parallel facing cutting edges 152B and a first cutting edge of the second set of parallel facing cutting edges 154B may be offset (e.g. stepped). However, in other examples, the respective first cutting edges may be in-line (e.g., parallel). In some examples, a second cutting edge from the first set of parallel facing cutting edges 152B and a second cutting edge of the second set of parallel facing cutting edges 154B may be offset (e.g. stepped). However, in other examples the respective second cutting edges may be in-line (e.g., parallel). Thus, within examples the first and second sets of parallel facing cutting edges 152B and 154A may share a centerline of symmetry, while in other examples the first and second sets of parallel facing cutting edges 152B and 154A may not share a centerline of symmetry.

Within examples, the first set of parallel facing cutting edges 152B may be configured to strip a first gauge size, and the second set of parallel facing cutting edges 154B may be configured to strip a second gauge size. The second gauge size may be different than the first gauge size. For example, the first set of parallel facing cutting edges 152B may be disposed on either side of the opening at a distance sufficient to cut insulation from a 12 gauge wire, and second set of parallel facing cutting edges 154B may be disposed on either side of the opening at a distance sufficient to cut insulation from a 14 gauge wire. However, other gauges and/or distances are possible.

The wire stripping assembly 150 may be included on any suitable tool, for example the handheld tool 100 and/or 200. In some examples, the wire stripping assembly 150 may be a separate tool (e.g., a standalone tool). Further, while the wire stripping assembly 150 shown in FIG. 8A includes a first and second set of parallel facing cutting blades 152A and 154A, respectively, the wire stripping assembly 150 may include more or less sets of parallel facing cutting blades and/or edges. In some examples, the wire stripping assembly 150 may include one set of parallel facing cutting blades and/or edges, two sets of parallel facing cutting blades and/or edges, three sets of parallel facing cutting blades and/or edges, four sets of parallel facing cutting blades and/or edges, or five sets of parallel facing cutting blades and/or edges. Thus, the example of FIG. 8A is not meant to be limiting on the number of sets of parallel facing cutting blades and/or edges included on the wire stripping assembly 150.

In function, the insulated wire may be inserted into the opening of the wire stripping assembly 150, with the wire preferably extending perpendicular to the cutting edges 152B and/or 154B. The insulated wire may be placed in contact with the parallel facing cutting blades corresponding to the gauge of the insulated wire being inserted. For example, a 14 gauge insulated wire may pass the set of parallel facing cutting blades corresponding to a 12 gauge insulated wire, but be placed in contact with the cutting edges of the set of parallel facing cutting blades corresponding to a the 14 gauge wire. Once in contact with the corresponding set of parallel facing cutting blades, the wire stripping assembly 150 may be rotated clockwise and/or counterclockwise such that the parallel facing cutting edges radially cut the insulation portion of the insulated wire. In some examples, the wire stripping assembly 150 and insulated wire may be rotated 90 degrees relative to each other. The insulated wire may be pulled generally from the wire stripping assembly 150 generally transverse to the blades 152A and 154A and the cut portion of insulation will then be stripped to expose the wire portion.

FIG. 8B is a bottom view of the wire stripping assembly 150, according to embodiment shown in FIGS. 1-4. The wire stripping assembly 150 includes a first piece 356B, a second piece 358B, a first set of parallel facing cutting edges 352B, and a second set of parallel facing cutting edges 354B. In the illustrated embodiment, the first piece 356B includes a first cutting edge from the first set of parallel facing cutting edges 352B and a first cutting edge of the second set of parallel facing cutting edges 354B, with the first cutting edges 352B and 354B being offset (e.g. stepped) from each other on the first piece 356B. The second piece 358B includes a second cutting edge from the first set of parallel facing cutting edges 352B and a second cutting edge of the second set of parallel facing cutting edges 354B, with the second cutting edges 352B and 354B being part of a single, continuous, straight cutting edge that defines both of the second cutting edges 352B and 354B. Like the sets of cutting edges 152B and 154B shown in FIG. 8A, the first set of cutting edges 352B are spaced by a first distance and the second set of cutting edges 354B are spaced by a second distance. Thus, like the example shown in FIG. 8A, the first set of cutting edges 352B can be spaced to strip a first size/gauge of insulated wire, such as 12 gauge wire, and the second set of cutting edges 354B can be spaced to strip a second size/gauge of insulated wire, such as 14 gauge wire, that is a smaller diameter than the first size/gauge. Again, like the example shown in FIG. 8A, the wire stripping assembly 150 of FIG. 8B may be included on any suitable tool, for example the handheld tool 100 and/or 200. In some examples, the wire stripping assembly 150 may be a separate tool (e.g., a standalone tool). Further, while the wire stripping assembly 150 shown in FIG. 8B includes a first and second set of parallel facing cutting edges 352B and 354B, respectively, the wire stripping assembly 150 may include more or less sets of parallel facing cutting blades and/or edges. In some examples, the wire stripping assembly 150 may include one set of parallel facing cutting blades and/or edges, two sets of parallel facing cutting blades and/or edges, three sets of parallel facing cutting blades and/or edges, four sets of parallel facing cutting blades and/or edges, or five sets of parallel facing cutting blades and/or edges. Thus, the example of FIG. 8B is not meant to be limiting on the number of sets of parallel facing cutting blades and/or edges included on the wire stripping assembly 150.

In some examples, the respective first cutting edges 352B and 354B on the first piece 356B may be in-line and the second cutting edges 352B and 354B on the second piece 358B from the first may be offset (e.g. stepped) on the second piece 358B. Thus, within examples, the first and second sets of parallel facing cutting edges 352B and 354B may share a centerline of symmetry (like the sets of parallel cutting edges 152B and 154B of FIG. 8A), while in other examples, such as the example shown in FIG. 8B, the first and second sets of parallel facing cutting edges 352B and 354B may not share a centerline of symmetry.

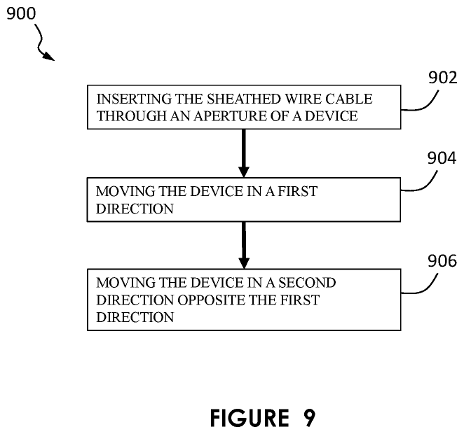

FIG. 9 is a flow chart of an example method 900 for removing a sheath from a sheathed wire cable, according to example embodiments. The above discussed examples of the handtool 100, 200, 400 are ideal for use as the device in the method 900. In some examples, at least a portion of the sheath may be removed by the method 900.

The method 900 may include one or more operations, or actions as illustrated by one or more blocks 902-906. Although the blocks are illustrated in a sequential order, these blocks may in some instances be performed in parallel, and/or in a different order than those described herein. Also, the various blocks may be combined into fewer steps, divided into additional steps, and/or removed based upon the desired implementation.

As illustrated, at block 902, the example method 900 includes inserting the sheathed wire cable through an aperture of a device.

At block 904, the example method 900 includes moving the device in a first direction. A first cutting edge slits the sheath along a longitudinal length of the sheath as the device is moved in the first direction.

At block 906, the example method 900 includes moving the device in a second direction opposite the first direction. A second cutting edge of the device cuts the sheath so as to detach a portion of the sheath from the wire.

In some examples, prior to moving the device in the second direction the method 900 may further include engaging the portion with an impingement.

In some examples, prior to moving the device in the second direction the method 900 may further include rotating the device 90 degrees in a radial direction.

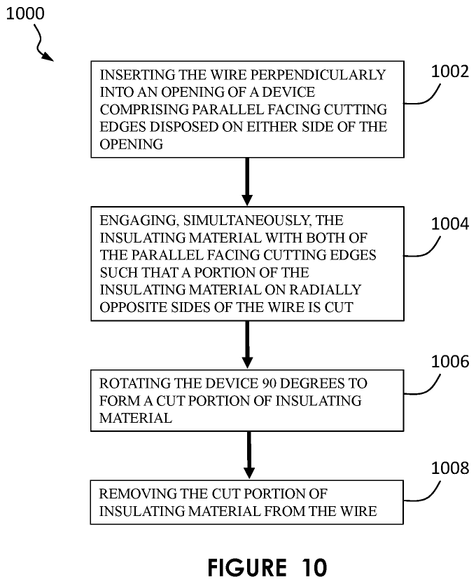

FIG. 10 is a flow chart of an example method 1000 for removing insulating material from a wire, according to example embodiments. In some examples, at least a portion of the insulating material may be removed by the method 1000. The examples of the wire stripper 150 discussed above are ideal for use as the device in method 1000.

The example method 1000 includes one or more operations, or actions as illustrated by one or more blocks 1002-1008. Although the blocks are illustrated in a sequential order, these blocks may in some instances be performed in parallel, and/or in a different order than those described herein. Also, the various blocks may be combined into fewer steps, divided into additional steps, and/or removed based upon the desired implementation.

As illustrated, at block 1002, the example method 1000 includes inserting the wire perpendicularly into an opening of a device comprising parallel facing cutting edges disposed on either side of the opening.

At block 1004, the example method 1000 includes engaging, simultaneously, the insulating material with both of the parallel facing cutting edges such that a portion of the insulating material on radially opposite sides of the wire is cut.

At block 1006, the example method 1000 include rotating the device 90 degrees to form a cut portion of insulating material.

At block 1008, the example method 1000 includes removing the cut portion of insulating material from the wire.

Preferred embodiments of the inventive concepts are described herein, including the best mode known to the inventor(s) for carrying out the inventive concepts. Variations of those preferred embodiments will become apparent to those of ordinary skill in the art upon reading the foregoing description. The inventor(s) expect skilled artisans to employ such variations as appropriate, and the inventor(s) intend that the inventive concepts can be practiced otherwise than as specifically described herein.

The use of the term “substantially” in the context of describing the invention (especially in the context of the following claims) may be construed as not exactly. The term “substantially” may indicate deviations from exact, such as intentional and/or unintentional deviations (e.g., manufacturing tolerances). In some examples, “substantially” may indicate one standard deviation from exactly, or two standard deviations from exactly. For example, “substantially” may mean a deviation from exactly between 0 and 10 percent, between 10 and 20 percent, between 30 and 40 percent, or between 40 and 50 percent. In other examples, “substantially” may mean a deviation from exactly between 0 and 10 degrees, between 10 and 20 degrees, between 20 and 30 degrees, between 30 and 40 degrees, or between 40 and 50 degrees.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. The use of any and all examples, or exemplary language (e.g., “such as”) provided herein, is intended merely to better illuminate the inventive concepts disclosed herein and does not pose a limitation on the scope of any invention unless expressly claimed. No language in the specification should be construed as indicating any non-claimed element as essential to the practice of the inventive concepts disclosed herein.

What is claimed is:

1. A device for removing the sheathing from an electrical cable, the device comprising:
a body having a first end, a second end opposite the first end, a longitudinal portion therebetween, and a passage extending through the longitudinal portion from the first end to the second end;
the second end defining a first terminal portion of a channel extending along at least a portion of the longitudinal portion of the body;
a first cutting edge disposed within the passage, the first cutting edge configured to cut a sheathing of an electrical cable extending through the passage upon the device being moved in a first direction relative to the electrical cable; and
a second cutting edge disposed at an angle to the first cutting edge at a second terminal portion of the channel opposite the first terminal portion, the second cutting edge configured to cut a sheathing from an electrical cable upon the device being moved in a second direction opposite the first direction with the sheathing extending into the channel.

2. The device of claim 1, wherein the first cutting edge has an arcuate profile.

3. The device of claim 1, wherein the second cutting edge is planar linear.

4. The device of claim 1, wherein the angle is orthogonal.

5. The device of claim 1, further comprising an impingement disposed in the channel proximate to the second cutting edge.

6. The device of claim 5, wherein the impingement is radially offset from the second cutting edge.

7. The device of claim 5, wherein the impingement is configured to restrain a material for cutting by the second cutting edge.

8. The device of claim 1, wherein the first terminal portion of the channel and the second terminal portion of the channel have a same centerline.

9. The device of claim 1, wherein the channel bends at an angle such that the first terminal portion of the channel is angularly offset from the second terminal portion of the channel.

10. The device of claim 1, wherein the body further comprises a magnet.

11. The device of claim 1, further comprising:
a wire stripping assembly disposed at the second end of the body, the wire stripping assembly comprising:
a first set of parallel facing cutting edges; and
a second set of parallel facing cutting edges offset from the first set, wherein the second set of parallel facing cutting edges is parallel to the first set.

12. The device of claim 1, wherein the longitudinal portion defines a longitudinal axis and the first and second directions is are parallel to the longitudinal axis.

13. A method for removing a sheath from a sheathed wire cable, the method comprising:
inserting the sheathed wire cable through an aperture of a device;
moving the device in a first direction, wherein a first cutting edge slits the sheath along a longitudinal length of the sheath as the device is moved in the first direction; and
moving the device in a second direction opposite the first direction, wherein a second cutting edge of the device cuts the sheath so as to detach a portion of the sheath from the wire.

14. The method of claim 13, wherein prior to moving the device in the second direction the method further comprises:
engaging the portion with an impingement.

15. The method of claim 13, wherein prior to moving the device in the second direction the method further comprises:
rotating the device 90 degrees in a radial direction.

16. A device comprising:
a body having a first end, a second end opposite the first end, and a passage extending through a longitudinal portion from the first end to the second end;
the second end defining a first terminal portion of a channel extending along at least a longitudinal portion of the body;
a first cutting edge disposed within the passage, the first cutting edge configured to cut a sheathing of an electrical cable extending through the passage when the device is moved in a first direction relative to the electrical cable;
a second cutting edge disposed at an angle to the first cutting edge at a second terminal portion of the channel opposite the first terminal portion, the second cutting edge configured to cut a sheathing from an electrical cable when the device is moved in a second direction opposite the first direction with the sheathing extending into the channel; and
a wire stripping assembly, at the second end of the body, having:
a first set of parallel facing cutting edges; and
a second set of parallel facing cutting edges offset from the first set of parallel facing cutting edges, the first and second sets of parallel facing cutting edges being parallel to one another.

17. The device of claim 16, wherein the first set and second set of parallel facing cutting edges share a centerline.

18. The device of claim 16, wherein the first set of parallel facing cutting edges is spaced by a first distance and the second set of parallel facing cutting edges is spaced by a second distance less than the first distance.

19. The device of claim 16, wherein the wire stripping assembly further comprises an opening adjacent to a first end of the first set to allow insertion of an insulated wire therebetween.

20. The device of claim 16, wherein a first cutting edge from the first set of parallel facing cutting edges and a first cutting edge from the second set of parallel facing cutting edges are defined by a first component, and a second cutting edge from the first set and a second cutting piece from the second set are defined by a second component fixed relative to the first component.
